(19) United States
(12) Patent Application Publication
(10) Pub. No.: US 2012/0266143 A1
(43) Pub. Date: Oct. 18, 2012

(54) RESOURCE COST CORRELATION ACROSS DIFFERENT SUBSYSTEMS

(75) Inventors: Mukundan Bhoovaraghavan, Hyderabad (IN); Raghuram Lanka, Hyderabad (IN); Deepak Raghuraman Aravindakshan, Hyderabad (IN); Sadagopan Rajaram, Hyderabad (IN)

(73) Assignee: MICROSOFT CORPORATION, Redmond, WA (US)

(21) Appl. No.: 13/114,056

(22) Filed: May 24, 2011

Related U.S. Application Data
(60) Provisional application No. 61/474,460, filed on Apr. 12, 2011.

(51) Int. Cl. G06F 9/44

(52) U.S. Cl. 717/127

(57) ABSTRACT

A program can include declarative programming elements corresponding to elements of an actual state data structure. Data can be collected while the program is running. The collected data can include resource cost data from different runtime subsystems. A model state data structure, which can represent a data structure that could have produced the resource cost data, can be constructed from the collected data. A correlation data structure can be generated using the model state data structure. The correlation data structure can correlate the resource cost data from the different runtime subsystems and can attribute units of the resource cost data to the programming elements. At least a portion of the cost data can be analyzed with different analyzers using the correlation data structure. Additionally, analysis results from the different analyzers for the resource cost data can be composed together.

### RELATED APPLICATIONS

This application claims priority to U.S. Provisional Patent Application No. 61/474,460, entitled RESOURCE COST CORRELATION ACROSS DIFFERENT SUBSYSTEMS, filed Apr. 12, 2011, which is incorporated herein by reference.

### BACKGROUND

Computer runtime environments can host programs while the programs are running. For example, a runtime environment may be a virtual environment running in a host computer system. Runtime environments can include multiple subsystems having different mechanisms for performing a variety of tasks.

Profilers are computing tools that are used to collect performance information such as resource cost data about running computer programs and present the collected information to a user. This is typically done with a profiler component that runs at the same time as a computer program to collect resource cost data for the computer program. The profiler can present such collected information to a developer to provide the developer with information about the performance of the running program.

### SUMMARY

The tools and techniques described herein can include correlating resource cost data from different subsystems of an environment where a program is running, and attributing the cost data to programming elements (i.e., components of the computer program that can be modified by user input from a program developer, such as scripts, source code, etc.) of that program. The tools and techniques may include constructing a correlation data structure that correlates units of the resource cost data from different subsystems and attributes resource cost data to the programming elements, and/or using such a data structure to analyze a dataset derived from the resource cost data.

As used herein, different runtime environment subsystems (sometimes referred to herein generally as different subsystems) are different types of subsystems of a runtime environment, which is an environment in which a program is run. For example, different subsystems could include a graphics subsystem, a user code execution subsystem, a media decoding subsystem, a networking subsystem, and an overall programming environment (an operating system abstraction layer that manages a lifetime of a running program). There can also be other different subsystems. For example, an operating system itself could be another example of a different subsystem if the scope of a system being profiled were to include the operating system. As another example, resources may be considered subsystems. For example, a GPU (graphics processing unit) may be considered as a subsystem, and a CPU (central processing unit) may be considered as another subsystem.

In one embodiment, the tools and techniques can include running a program in a computer system. The program can include declarative programming elements corresponding to elements of an actual state data structure that is maintained while the program is running. Data can be collected while the program is running. The collected data can include resource cost data from multiple different runtime subsystems in the computer system. A model state data structure can be constructed from the collected data. The model state data structure can represent a data structure that could have produced the resource cost data. A correlation data structure can be generated using the model state data structure. The correlation data structure can correlate the resource cost data from the different runtime subsystems and can attribute units of the resource cost data to the programming elements.

In another embodiment of the tools and techniques, a computer program can run in a computer system. The program can include programming elements corresponding to elements of an actual state data structure that is maintained while the program is running. Data that includes resource cost data can be collected from multiple different runtime subsystems in the computer system while the program is running. An indication to analyze at least a portion of the resource cost data can be received. At least a portion of the cost data can be analyzed with different analyzers using a correlation data structure that correlates the resource cost data from the different runtime subsystems and attributes units of the resource cost data to the programming elements. Additionally, analysis results from the different analyzers for the resource cost data can be composed together.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a schematic diagram of a resource cost data correlation system.

FIG. 3 is a schematic diagram of a correlation data structure.

FIG. 4 is a schematic diagram of an analyzer flow.

FIG. 5 is a flowchart of a resource cost data correlation technique.

FIG. 6 is a flowchart of another resource cost data correlation technique.

FIG. 7 is a flowchart of yet another resource cost data correlation technique.

### DETAILED DESCRIPTION

Embodiments described herein are directed to techniques and tools for improved analysis of the resource cost data and/or correlation of resource cost data and attributing resource cost data to programming elements. Such improvements may result from the use of various techniques and tools separately or in combination.

Such techniques and tools may include measuring performance metrics and measures to relate resource use cost to individual programming elements across different subsystems. Wall clock time can be used to calculate when individual workloads executed and when the associated costs were incurred. Resource time (e.g., CPU or GPU execution time) or other metrics such as memory usage may be used to quantify and represent the associated resource costs. Resource cost data from different subsystems may be correlated and units of the data may be attributed to individual declarative and/or imperative programming elements based on an execution trace and on the design of a runtime module that is running the program during execution. Information from the different subsystems can be used to correlate resource cost data from different subsystems and attribute the cost data to programming elements. Cost data metrics may or may not correlate to programming elements on a one-to-one basis. For example, for imperative constructs, mapping between collected metrics and programming elements may be a one-to-one mapping. For declarative constructs, mapping between collected metrics and programming elements may include multiple metrics mapping to one declarative programming element.

Accordingly, one or more benefits can be realized from the tools and techniques described herein. For example, information on resource costs may be presented to a user such as a developer in meaningful ways, allowing a developer to be informed as to how costs are distributed, and possibly how programming elements can be modified to improve performance of the program. As an example, a developer may be able to modify a program to perform some functions on a GPU, rather than in a CPU, if that change would decrease the resource costs (e.g., decreasing execution time), and thereby improve overall performance of the program.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

Techniques described herein may be used with one or more of the systems described herein and/or with one or more other systems. For example, the various procedures described herein may be implemented with hardware or software, or a combination of both. For example, dedicated hardware implementations, such as application specific integrated circuits, programmable logic arrays and other hardware devices, can be constructed to implement at least a portion of one or more of the techniques described herein. Applications that may include the apparatus and systems of various embodiments can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

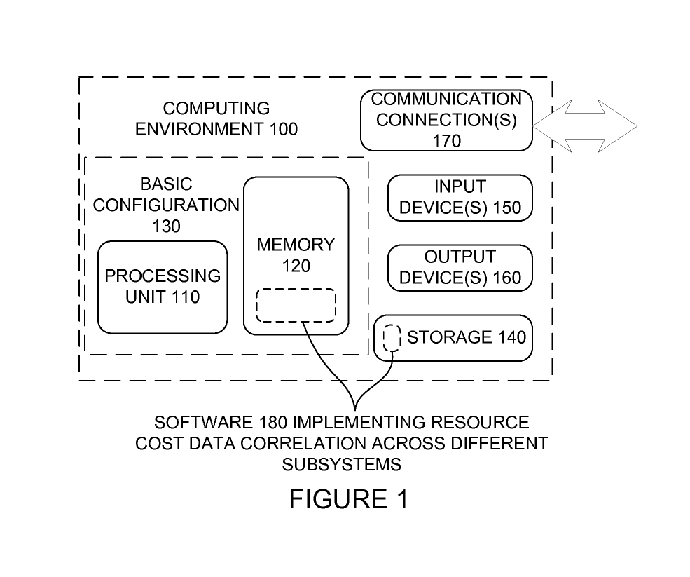

FIG. 1 illustrates a generalized example of a suitable computing environment (100) in which one or more of the described embodiments may be implemented. For example, one or more such computing environments can be used as a cost data correlation system. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and at least one memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The at least one memory (120) may be volatile memory (e.g., registers, cache, RAM), non-volatile memory (e.g., ROM, EEPROM, flash memory), or some combination of the two. The at least one memory (120) stores software (180) implementing resource cost data correlation across different subsystems.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Resource Cost Data Correlation System and Environment

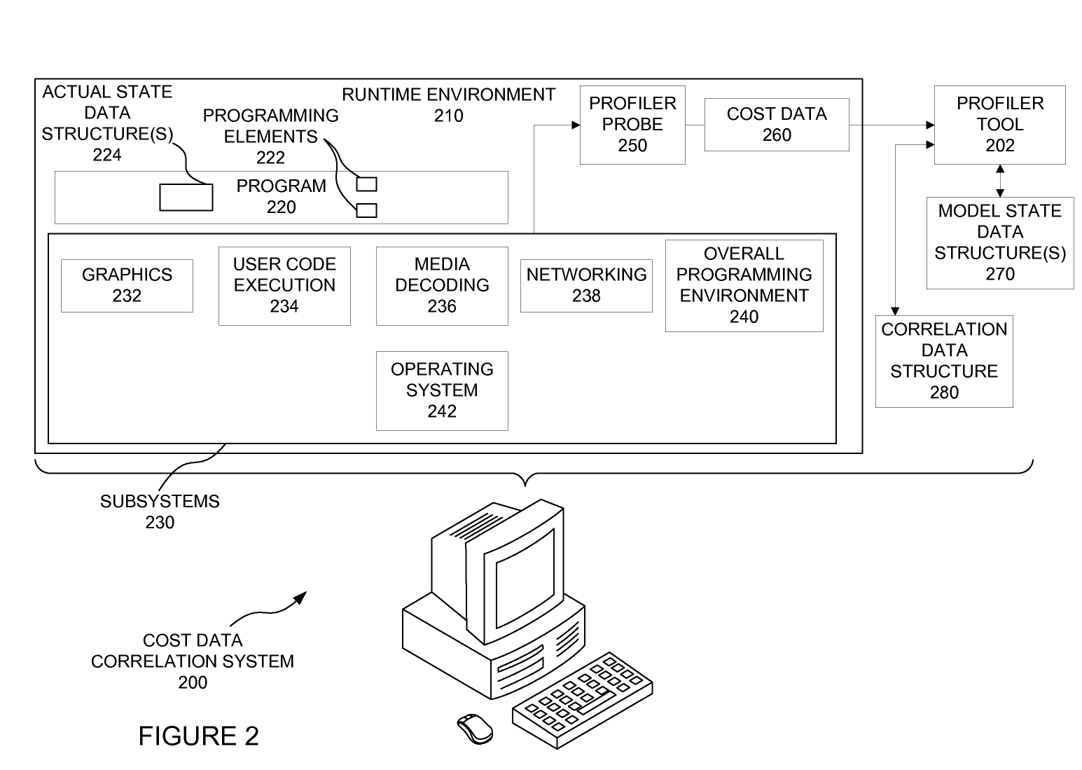

FIG. 2 is a schematic diagram of a resource cost data correlation system (200) in conjunction with which one or more of the described techniques and tools may be implemented. The system (200) can include a profiler tool (202), which can be a program module running in the system (200). The profiler tool (202) can receive user input, such as user input requesting that a runtime environment (210) be launched to run a program (220). For example, the runtime environment (210) may be a native environment in the system (200). Alternatively, the runtime environment (210) can be a virtual environment that simulates a target environment in which the program (220) is to be run after the program (220) is developed. The program (220) can include programming elements (222). The programming elements (222) can be in any of various forms, such as source code (which can be edited, but can be compiled to run in the runtime environment (210)), scripts, etc. The programming elements (222) may include declarative programming elements and may also include imperative programming elements.

One or more actual state data structures (224) can be defined by the program (220) and can be maintained by the runtime environment (210) when the program (220) is running. For example, a state data structure (224) may be a tree structure, such as a tree that defines a user interface in a declarative manner. The state data structure(s) (224) are illustrated within the program (220) in FIG. 2 because the program (220) can define the state data structure(s) (224), but the actual state data structure(s) (224) may exist in a different form when being used in the runtime environment (210) than originally in the program (220). The actual state data structure(s) (224) may be obtained by sampling, using a call stack analysis.

As the program (220) is run in the runtime environment (210), multiple different subsystems (230) in the runtime environment (210) can be involved in supporting and running the program (220). For example, the subsystems (230) may include a graphics subsystem (232), a user code execution subsystem (234), a media decoding subsystem (236), a networking subsystem (238), an overall programming environment subsystem (240), and an operating system (242). Alternatively, the operating system (242) may not be considered to be one of the subsystems (230) to be profiled in some situations, such as where the analysis is to be focused on subsystems other than the operating system (242).

A profiler probe (250) running in the runtime environment (210) can collect data including cost data (260) as the program (220) runs. This cost data (260) can be integrated cost data from the different subsystems (230). The profiler probe (250) can communicate the cost data (260) to the profiler tool (202), which may run outside the runtime environment (210), as illustrated. Alternatively, the profiler tool (202) may run inside the runtime environment (210), and may also act as the profiler probe (250). As an example, the cost data (260) may be collected in one or more trace log files.

The profiler may use the collected data including the cost data (260) to construct one or more model state data structure(s) (270) that can be used to map items from the cost data (260) to the actual state data structure(s) (224), which can include or be mapped to the programming elements (222) of the program (220). A model state data structure (270) can match a corresponding actual state data structure (224). For example, if an actual state data structure (224) is a tree data structure, the matching model state data structure (270) may also be a tree data structure. Other data structures could be used as well. For example, a list of nodes created during execution time can be maintained, and a separate structure can track the parent of a given node at a given time. Accordingly, this structure can represent a list of nodes with each node having information on the parent and the time for which the parent node was active. When a tree structure is to be created for a given time, a scan can be performed through each node in the list to identify the parent of the current node at that time. The current node can be added to the tree structure as a child of the identified parent node.

As an example of constructing a model state data structure (270), the cost data (260) may be included in an execution trace log file generated while running the program (220). The cost data (260) and the other collected data in that trace file can come from multiple different subsystems (230). The profiler probe (250) may insert markers in the code of the program (220), so that such markers trigger events that are recorded in the trace log file. The data for each such event may include a system clock time (wall clock time) for the event. For example, a log entry for an execution time on a processor may include start and/or stop system wall clock times. For resource usage that is measured in units of time, a log entry may also include a resource time for the particular trace. For example, the entry may indicate an amount of execution time on a GPU or CPU. Log entries may also include other information, such as the amount of memory allocated for a particular element corresponding to an element of a state data structure (224), a frame rate at a particular wall clock time, etc. Because the log file can include such resource usage entries from all the different subsystems (230) that are to be included in the profile, those usages can be combined to reveal the overall resource usage by imperative components being profiled in the runtime environment (210).

The cost data (260) may also include some unwanted data, such as data from resource usage by the profiler probe (250) as the probe (250) collects the cost data (260). Such unwanted cost data may be identified and subtracted out by the profiler probe (250) and/or the profiler tool (202). This may be done by actually measuring costs contributed by the profiler probe (250). However, measuring the costs of the profiler probe (250) may introduce even more unwanted costs. Accordingly, the unwanted costs may be quantified in some other manner, such as by estimating costs contributed by the profiler probe (250). For example, estimates can be based on how many cost samples were taken by the profiler probe (250) and/or based on some other information. Rather than actually subtracting out the costs, information about unwanted costs may be presented along with representations of the cost data (260) itself. For example, information on tolerances for the cost data (260) may be presented.

As noted above, the cost data (260) can reveal the costs of the imperative elements from the runtime environment (210). However, at least some of those imperative elements may not be actual programming elements (222) of the program (220). For example, where the programming elements (222) are declarative programming elements, the subsystems (230) of the runtime environment (210) may execute those declarative programming elements by invoking imperative elements of the runtime environment (210) that specify how tasks identified by the declarative programming are to be executed. Accordingly, the profiler tool (202) may include tools that that correspond to designs in the runtime environment (210), and those tools can identify conditions that would have been caused by the particular runtime environment (210) executing particular types of declarative programming elements from the program (220). For example, declarative languages are often exhibited by corresponding engines. Using a knowledge of how an engine works and of a profile of time taken by particular components in the runtime environment (210) when running the program (220), a mapping can be generated of what declarative elements would have caused the time and component profile. Accordingly, tools may be used to construct the model state data structure (270), which can represent a state data structure (270) that could have produced the collected data including the cost data (260).

The model state data structure (270) may include elements that correspond to different types of declarative programming elements, and may also include some elements that correspond to types of imperative programming elements. Accordingly, the model state data structure(s) (270) can match the actual state data structure(s) (224) that were present when the program (220) was running in the runtime environment (210). Thus, elements of the model state data structures (270), which are already matched to items in the cost data (260) can be matched to structures in the program (220) that include the programming elements (222).

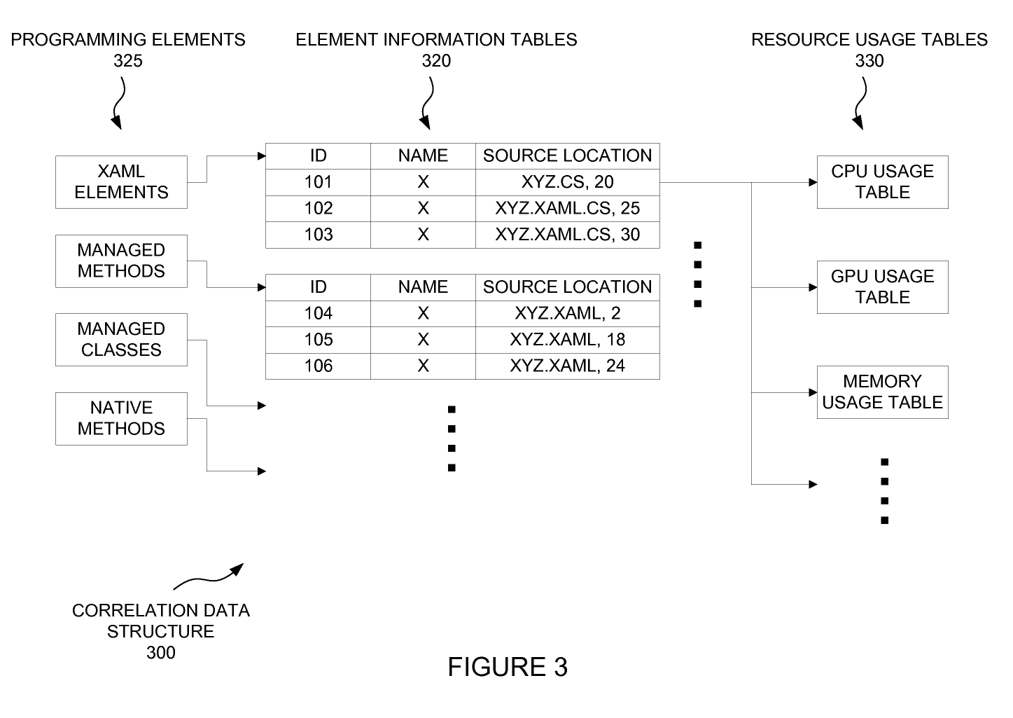

Accordingly, the profiler tool (202) can use the model state data structure(s) (270) to match items in the cost data (260) to the programming elements (222) in the program (220), even when those programming elements (222) are declarative elements. That matching can be used to construct the correlation data structure (280), which can correlate the cost data (260) for different subsystems (230) and can also attribute items in the cost data (260) to the matching programming elements (222). The cost data (260) for different subsystems may be correlated using timing information from the trace log file, which can also be included in the correlation data structure (280). For example, items of the cost data (260) identifying memory usage by different subsystems (230) at a particular wall clock time may be combined and summed to reveal an overall memory usage for that time. The correlation data structure (280) may include one or more tables, such as a table for each type of cost being profiled (e.g., one table for memory usage, one table for GPU usage, one table for CPU usage, etc.). For example, referring to FIG. 3, a correlation data structure (300) may include element information tables (320) for each type of programming element (325). In one example, as illustrated, the element information tables (320) may include a table for XAML elements, a table for managed methods, a table for managed classes, a table for native methods, etc. The element information tables (320) can include entries that each include information about a corresponding programming element (325). For example, an entry in an element information table (320) may indicate that an element has identification “101”, name “X”, and source location “XYZ.CS, 20.” Each entry in the element information tables (320) can be linked to cost data related to the corresponding programming element (325), such as by including one or more references to data in one or more resource usage tables (330). For example, the resource usage tables (330) may include a CPU usage table, a GPU usage table, a memory usage table, a handle usage table, etc.

As noted above, the correlation data structure (280) can correlate cost data from different subsystems (230). For example, consider a declarative programming element (222) that indicates a text box. The user code execution subsystem (234), the graphics subsystem (232), and the GPU may each have memory allocated for the text box. Accordingly, to calculate how much memory the text box programming element is using, information from the different subsystems can be combined. The memory usage by different subsystems can be tracked by tracking what objects are allocated by what other objects. For example, object A may be allocated by the user code, object A may allocate object B, object B may allocate object C, etc. And these objects may be allocated in different subsystems (230). The tracking of this allocation can be maintained down to the processor level (e.g., including memory allocated in the GPU). These allocations from different subsystems can then be correlated to the object that was allocated by the programming element (222) in the memory table. Also, the memory table may include an indication of a subsystem (e.g., user code execution subsystem (234), graphics subsystem (232), GPU subsystem, etc.) from which an item of memory allocation was derived.

The correlation data structure (280) can include multiple different sub-structures, such as multiple different tables that can be constructed from trace file information using knowledge of the design of the runtime environment (210). For example, one table may include a graph that maps between different objects from the runtime environment (210). For example, that graph can identify relationships such as parent-child relationships between the objects. That graph may be used in constructing the model state data structure(s) (270). Other tables correlate items of resource usage by time and may attribute each usage item to a programming element that was responsible for the usage. For example, tables in the correlation data structure (280) may include a table that maps memory usage to objects, a table that maps GPU usage to objects, a table that maps CPU usage to objects, etc.

The correlation data structure (280) can be analyzed to provide information related to the costs attributed to the programming elements (222). For example, the profiler tool (202) may apply a series of filters and/or analyzers to the data in the correlation data structure (280). This filtering and/or analysis may be done in response to user input.

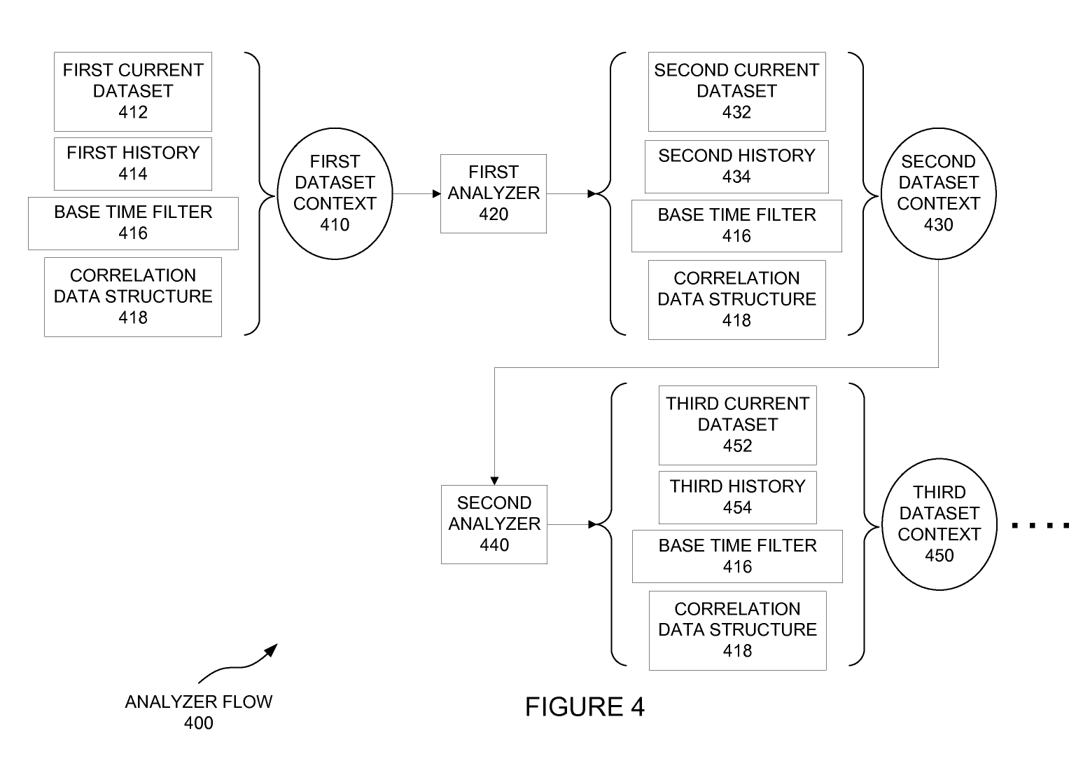

The analyzers and filters may be applied in various ways. One example of an analyzer flow (400) is illustrated in FIG. 4, and will now be discussed. In the analyzer flow (400), a first dataset context (410) can include various data items. The first dataset context (410) may be an initial dataset context before other filters or analyzers have been applied, or the first dataset context (410) may be received from a previous filter or analyzer. The first dataset context can include a first current dataset (412), which can be a dataset that results from previous filters and/or analyzers being applied to the cost data in the correlation data structure. The first dataset context (410) can also include a first history (414), which can represent a history of analyzers and/or filters that were already applied to produce the first current dataset (412). The first dataset context (410) can also include a base time filter (416), which can filter the data to be within a specified range of time (such as a range of system wall clock time). The first dataset context (410) can also include a correlation data structure (418), which may be the same as the correlation data structure (280) discussed above with reference to FIG. 2. The first current dataset (412), or at least a portion of the first current dataset (412), may be presented to a user, such as by displaying a representation of at least a portion of the first current dataset.

The first dataset context (410) can be provided to a first analyzer (420), which may be a component of the profiler tool (202) of FIG. 2. For example, this may be done in response to receiving user input. The first analyzer (420) can analyze the first dataset context (410) to produce a second dataset context (430), which can include an updated second current dataset (432), and updated second history (434) (which can be updated to indicate that the first analyzer (420) had analyzed the data), the base time filter (416), and the correlation data structure (418). The second current dataset (432), or at least a portion of the second current dataset (432), may be presented to a user, such as by displaying a representation of at least a portion of the second current dataset (432). The second dataset context (430) can be provided to a second analyzer (440), and the second analyzer can analyze the second dataset context (430) to produce a third dataset context (450). For example, this may be done in response to user input. The third dataset context (450) can include an updated third current dataset (452), an updated third history (454), the base time filter (416), and the correlation data structure (418). The third current dataset (452), or at least a portion of the third current dataset (452), may be presented to a user, such as by displaying a representation of at least a portion of the third current dataset (452). This sequence of displaying a current dataset, providing the current dataset to another analyzer, having the analyzer analyze the dataset context to produce another current dataset, and then displaying that current dataset may continue beyond what is illustrated in FIG. 4. For example, the sequence may continue until a programming element is identified and displayed so that a user can edit that programming element.

Referring to FIGS. 2 and 4, and as one example of an analysis, consider a situation where a frame rate drops too low while the program (220) is running. The low frame rate could cause a display screen to flicker. Such a low frame rate could be caused by one or more of many things (e.g., other program(s) using too many resources, the cost of executing the current display screen being too high, some other thread in the program using too many resources, etc.). The first analyzer (420) may be able to reveal that between system wall clock times t=1 and t=2, the problem resulted from the complexity of a visual tree structure. The second analyzer (440) may be able to analyze between times t=1 and t=2 to determine which programming elements of the visual tree structure are incurring the largest resource costs during that time period. An additional third analyzer (not shown) may be invoked to reveal which animations (which can themselves be programming elements) are causing the properties of those high cost programming elements to change during this time period. When representations of the animation programming elements are displayed as part of a resulting current dataset from the third analyzer, user input may be provided to click on the representation of an animation programming element to reveal the animation programming element itself. The animation programming element can then be edited. In each of the levels of analysis, user input may be provided to drill down further and invoke additional analyzers to assemble and display datasets.

The analyzers can perform various different types of analyses on the cost data. For example, one analyzer may receive data within a specified time period and determine what elements are being modified during that time. Another analyzer may receive elements that have been modified, and that analyzer may yield the storyboards that were causing the elements to be modified. Another analyzer may sort data to see which has the greatest resource cost (most execution time, most memory, etc.). A declarative model may be used by the profiler tool (202) to indicate what analyzers are applicable in specified situations. For example, available analyzers may be limited to different aspects depending what type of resource cost or usage is being analyzed and what associated sub-structure of the correlation data structure (280) will be used (frame rate table, memory usage table, CPU usage table, GPU usage table, etc.).

### III. Resource Cost Data Correlation Techniques

Several resource cost data correlation techniques will now be discussed. Each of these techniques can be performed in a computing environment. For example, each technique may be performed in a computer system that includes at least one processor and at least one memory including instructions stored thereon that when executed by the at least one processor cause the at least one processor to perform the technique (one or more memories store instructions (e.g., object code), and when the processor(s) execute(s) those instructions, the processor(s) perform(s) the technique). Similarly, one or more computer-readable storage media may have computer-executable instructions embodied thereon that, when executed by at least one processor, cause the at least one processor to perform the technique.

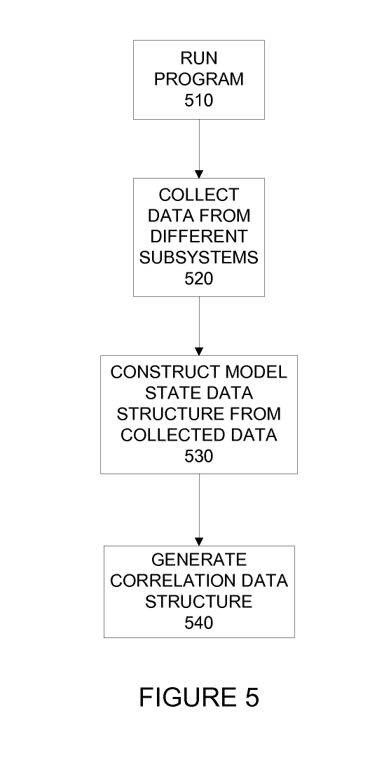

Referring to FIG. 5, a resource cost data correlation technique will be described. The technique can include running (510) a program in a computer system. The program can include multiple declarative programming elements corresponding to elements of an actual state data structure that is maintained while the program is running (510). Data that includes resource cost data can be collected (520) from multiple different runtime subsystems in the computer system while the program is running. A model state data structure can be constructed (530) from the collected data. The model state data structure can represent a data structure that could have produced the resource cost data. The technique can also include generating (540) a correlation data structure that correlates the resource cost data from the different runtime subsystems and attributes units of the resource cost data to the programming elements. The generation (540) of the correlation data structure can use the model state data structure.

The technique of FIG. 5 may further include receiving an indication to analyze at least a portion of the resource cost data. At least a portion of the resource cost data can be analyzed with different analyzers using the correlation data structure. Analysis results for the resource cost data from the different analyzers can be composed together into an integrated set of analysis results. A representation of the analysis results can be displayed, and the display can include displaying different sets of results from different analyzers. The analysis results may include a representation of one or more programming elements from the program.

Also, the analysis results can include one or more suggestions for modifying one or more of the programming elements. Such suggestions may be derived from patterns or conditions that can be identified by one or more of the analyzers. For example, the suggestions could be for different settings, different approaches to the code in the programming elements, etc. As one example, in some situations, performance may be improved if a user interface element is cached as a bitmap, rather than reconstructing the element each time it is to be rendered. In other situations, such bitmap caching may hinder performance, such as where the user interface element is not used frequently or where the user interface element is frequently changed. Accordingly, an analyzer may be configured to determine whether it would be useful to cache the bitmap, determine whether the bitmap is already being cached, and suggest a corresponding modification to the code for the user interface element if it appears that such a modification would improve performance.

The correlation data structure may include one or more tables. The actual state data structure and the model state data structure may be a tree structures.

Running (510) the program can include running the program in a runtime environment having a runtime module that processes the declarative programming elements according to one or more imperative techniques. Constructing (530) the model state data structure form the collected data can include invoking one or more reconstruction techniques corresponding to at least one of the one or more imperative techniques.

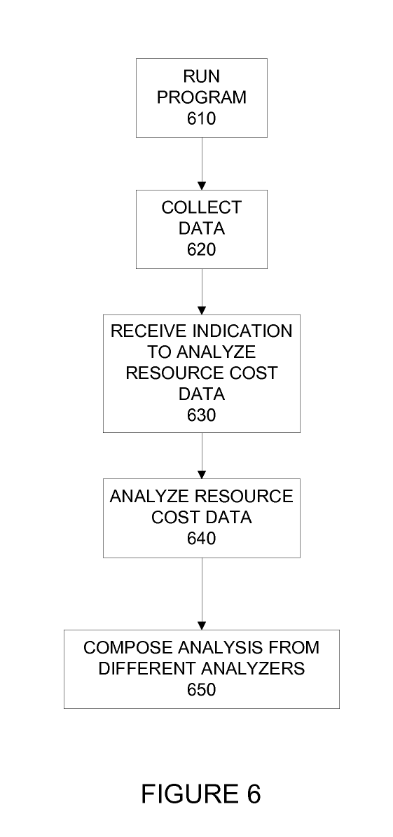

Referring to FIG. 6, another resource cost data correlation technique will be described. The technique can include running (610) a program in a computer system. The program can include multiple programming elements (which can be declarative and/or imperative programming elements) corresponding to elements of an actual state data structure that is maintained while the program is running. Data that includes resource cost data from multiple different runtime subsystems in the computer system can be collected (620) while the program is running. An indication to analyze at least a portion of the resource cost data can be received (630). At least a portion of the resource cost data can be analyzed (640) with different analyzers using a correlation data structure that correlates the resource cost data from the different runtime subsystems and attributes units of the resource cost data to the programming elements. Analysis results for the resource cost data from the different analyzers can be composed together (650). The technique may also include displaying a representation of the analysis results, and different sets of results from different analyzers may be displayed. The analysis results may include a representation of one or more programming elements from the program. The analysis results may include one or more suggestions for modifying one or more of the programming elements.

The technique of FIG. 6 may further include constructing a model state data structure from the collected data. The model state data structure can represent a data structure that could have produced the resource cost data. The correlation data structure can be generated using the model state data structure. The programming elements may include declarative programming elements.

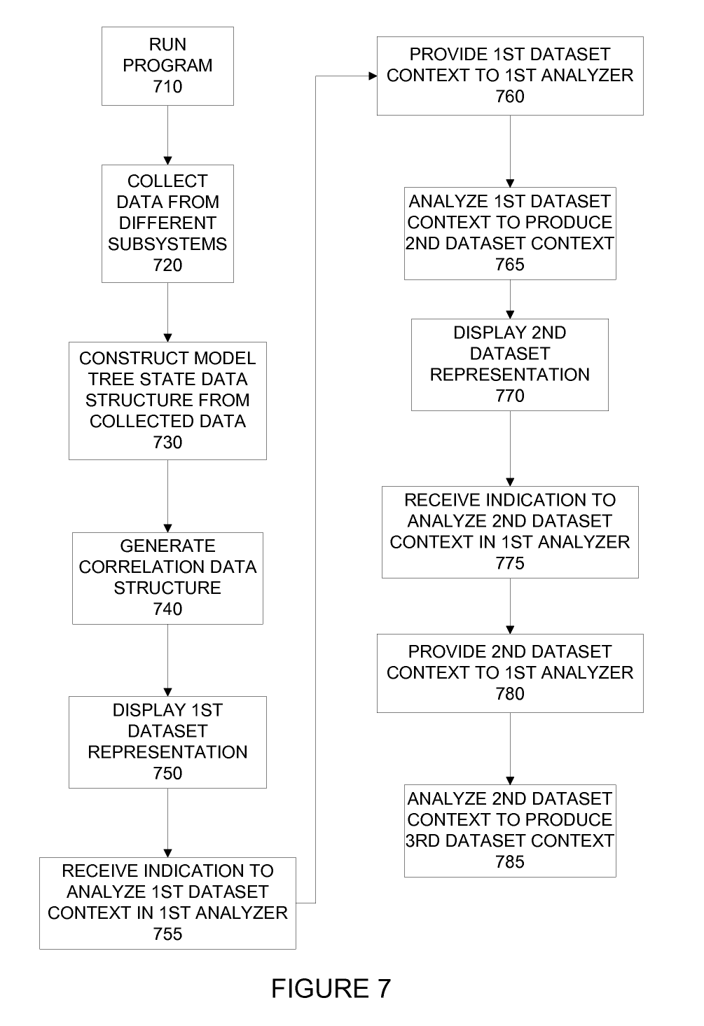

Referring to FIG. 7, yet another resource cost data correlation technique will be described. The technique can include running (710) a program in a runtime environment in a computer system. The runtime environment may have a runtime module that processes declarative programming elements of the program according to one or more imperative techniques. The declarative programming elements can correspond to elements of an actual state tree data structure that is maintained while the program is running. Data that includes resource cost data can be collected (720) from multiple different runtime subsystems in the computer system while the program is running. A model tree state data structure can be constructed (730) from the collected data. The model stat data structure can represent a data structure that could have produced the resource cost data. Constructing (730) the model state data structure can include invoking one or more reconstruction techniques corresponding to at least one of the one or more imperative techniques. A correlation data structure can be generated (740). The correlation data structure can correlate the resource cost data across the different subsystems and can attribute units of the resource cost data to the programming elements. The generation (740) of the correlation data structure can use the model state data structure.

Referring still to FIG. 7, a representation of a first current dataset can be displayed (750). An indication to analyze a first dataset context in a first analyzer can be received (755), where the first dataset context includes the first current dataset, which can be derived from the resource cost data and the correlation data structure. The first dataset context can be provided (760) to the first analyzer. The first analyzer can analyze (765) the first dataset context to produce a second dataset context. The second dataset context can include a second current dataset defined by the first analyzer using the correlation data structure. A representation of at least a portion of the second current dataset can be displayed (770). An indication to analyze the second dataset context can be received (775). The second dataset context can include the second current dataset and the correlation data structure. The second dataset context can be provided (780) to the second analyzer. The second analyzer can analyze (785) the second dataset context to produce a third dataset context. The third dataset context can include a third current dataset defined by the first analyzer using the correlation data structure. At least a portion of the third current dataset may be displayed. Also, the third current dataset may include a representation of programming elements from the program and/or suggestion(s) of modifications to be made to one or more programming elements.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. A computer-implemented method, comprising:
running a program in a computer system, the program comprising multiple declarative programming elements corresponding to elements of an actual state data structure that is maintained while the program is running;
collecting data comprising resource cost data from multiple different runtime subsystems in the computer system while the program is running;
constructing a model state data structure from the collected data, the model state data structure representing a data structure that could have produced the resource cost data; and
generating a correlation data structure that correlates the resource cost data from the different runtime subsystems and attributes units of the resource cost data to the programming elements, the generation of the correlation data structure using the model state data structure.

2. The method of claim 1, further comprising:
receiving an indication to analyze at least a portion of the resource cost data;
analyzing at least a portion of the resource cost data with different analyzers using the correlation data structure; and
composing analysis results for the resource cost data from the different analyzers.

3. The method of claim 2, further comprising displaying a representation of the analysis results.

4. The method of claim 3, wherein displaying the representation of the analysis results comprises displaying different sets of results from different analyzers.

5. The method of claim 2, wherein the analysis results comprise a representation of one or more programming elements from the program.

6. The method of claim 2, wherein the analysis results comprise one or more suggestions for modifying one or more of the programming elements.

7. The method of claim 1, wherein the correlation data structure comprises one or more tables.

8. The method of claim 1, wherein the actual state data structure is a tree structure.

9. The method of claim 8, wherein the model state data structure is a tree structure.

10. The method of claim 1, wherein running the program in the computer system comprises running the program in a runtime environment having a runtime module that processes the declarative programming elements according to one or more imperative techniques, and wherein constructing the model state data structure from the collected data comprises invoking one or more reconstruction techniques corresponding to at least one of the one or more imperative techniques.

11. One or more computer-readable storage media having computer-executable instructions embodied thereon that, when executed by at least one processor, cause the at least one processor to perform acts comprising:
running a program in a computer system, the program comprising multiple programming elements corresponding to elements of an actual state data structure that is maintained while the program is running;
collecting data comprising resource cost data from multiple different runtime subsystems in the computer system while the program is running;
receiving an indication to analyze at least a portion of the resource cost data;
analyzing at least a portion of the resource cost data with different analyzers using a correlation data structure that correlates the resource cost data from the different runtime subsystems and attributes units of the resource cost data to the programming elements; and
composing analysis results for the resource cost data from the different analyzers.

12. The one or more computer-readable storage media of claim 11, wherein the acts further comprise displaying a representation of the analysis results.

13. The one or more computer-readable storage media of claim 11, wherein the acts further comprise displaying different sets of results from different analyzers.

14. The one or more computer-readable storage media of claim 11, wherein the analysis results comprise a representation of one or more programming elements from the program.

15. The one or more computer-readable storage media of claim 11, wherein the analysis results comprise one or more suggestions for modifying one or more of the programming elements.

16. The one or more computer-readable storage media of claim 11, wherein the acts further comprise:
constructing a model state data structure from the collected data, the model state data structure representing a data structure that could have produced the resource cost data; and
generating the correlation data structure, the generation of the correlation data structure using the model state data structure.

17. The one or more computer-readable storage media of claim 16, wherein the programming elements comprise declarative programming elements.

18. A computer system comprising:
at least one processor; and
at least one memory comprising instructions stored thereon that when executed by the at least one processor cause the at least one processor to perform acts comprising:
running a program in a runtime environment in the computer system, runtime environment having a runtime module that processes declarative programming elements of the program according to one or more imperative techniques, the declarative programming elements corresponding to elements of an actual state tree data structure that is maintained while the program is running;
collecting data comprising resource cost data from multiple different runtime subsystems in the computer system while the program is running;
constructing a model tree state data structure from the collected data, the model state data structure representing a data structure that could have produced the resource cost data, constructing the model state data structure from the collected data comprising invoking one or more reconstruction techniques corresponding to at least one of the one or more imperative techniques; and
generating a correlation data structure that correlates the resource cost data across the different subsystems and attributes units of the resource cost data to the programming elements, the generation of the correlation data structure using the model state data structure;
receiving an indication to analyze a first dataset context in a first analyzer, the first dataset context comprising a first current dataset derived from the resource cost data and the correlation data structure;
providing the first dataset context to the first analyzer;
the first analyzer analyzing the first dataset context to produce a second dataset context, the second dataset context comprising a second current dataset defined by the first analyzer using the correlation data structure;
receiving an indication to analyze the second dataset context in a second analyzer, the second dataset context comprising the second current dataset and the correlation data structure;
providing the second dataset context to the second analyzer; and
the second analyzer analyzing the second dataset context to produce a third dataset context, the third dataset context comprising a third current dataset defined by the first analyzer using the correlation data structure.

19. The computer system of claim 18, wherein the acts further comprise displaying a representation of at least a portion of the first current dataset, displaying a representation of at least a portion of the second current dataset, and displaying a representation of at least a portion of the third current dataset.

20. The computer system of claim 19, wherein the third current dataset comprises a representation of programming elements from the program.
